(19) United States
(12) Patent Application Publication
(10) Pub. No.: US 2006/0090840 A1
(43) Pub. Date: May 4, 2006

(54) Method and apparatus for fabricating a flexible belt

(75) Inventors: Satchidanand Mishra, Webster, NY (US); Robert C. U. Yu, Webster, NY (US); Surendar Jeyadev, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/085,414

(22) Filed: Mar. 21, 2005

Related U.S. Application Data
(60) Provisional application No. 60/623,707, filed on Oct. 29, 2004.

(51) Int. Cl. B32B 37/00

(52) U.S. Cl. 156/217; 156/256; 156/304.5

(57) ABSTRACT

A method of fabricating an endless flexible belt having a circumference L1 and a thin seam profile. The method includes (a) cutting a work sheet of flexible belt material from a web of such material so that the work sheet has a first end and a first end region, a second end and a second end region, and a length L2 that is D units greater than L1; (b) looping the work sheet and overlapping the first end region and the second end region thereof by D units to form an overlapping dual end region; (c) making a single slice through the overlapping dual end region to produce a first, male side and a second, female side of the slice, and to produce a belt-length sheet, the first, male side of the slice comprising a first, male end of the belt-length sheet, and the second, female side of the slice comprising a second, female end of the belt-length sheet; (d) looping the belt-length sheet, re-aligning and mating the first, male side and the second, female side of the single slice to form a no-discrepancy abutment; and (e) heating and fusing the no-discrepancy abutment to form an endless flexible belt having a thin profile seam including no undesirable thickness variations and no undesirable protrusions.

### CROSS REFERENCE TO RELATED APPLICATIONS

This application claims the benefit of Provisional Patent Application No. 60/623,707 filed Oct. 29, 2004.

### BACKGROUND OF DISCLOSURE

This disclosure relates in general to a method of fabricating a flexible belt that includes a thin profile seam having no undesirable seam region thickness or protrusions. More specifically, this disclosure relates to a method of creating a thin and smooth profile seam for flexible electrostatographic imaging member belts having a number of morphological improvements.

Flexible imaging member electrostatographic belts as disclosed in prior art examples below, are well known in the art. Typical flexible electrostatographic imaging member belts include, for example, photoreceptors for electrostatographic imaging systems, electroreceptors such as ionographic imaging members for electrographic imaging systems, and intermediate image transfer belts for transferring toner images in electrostatographic and electrographic imaging systems. These belts are usually formed by cutting a rectangular, a square, or a parallelogram shape sheet from a web containing at least one layer of thermoplastic polymeric material, overlapping opposite ends of the sheet, and joining the overlapped ends together to form a seam. The seam typically extends from one edge of the belt to the opposite edge.

Generally, seamed imaging belts comprise at least a flexible supporting substrate and at least one imaging layer comprising thermoplastic polymeric matrix material. The “imaging layer” as employed herein is defined as the dielectric imaging layer of an electroreceptor belt, the transfer layer of an imaging belt and, the charge transport layer of an electrostatographic belt. Thus, the thermoplastic polymeric matrix material in the imaging layer is located in the upper portion of a cross section of an electrostatographic imaging member belt, the substrate layer being in the lower portion of the cross section of the electrostatographic imaging member belt. However, typical seamed electrostatographic imaging member belts do also require an anti-curl back coating to render desired belt flatness.

Flexible seamed electrostatographic imaging member belts thus are multilayered and include the substrate layer, the electrically conductive layer, and in addition an optional hole blocking layer, an adhesive layer, a charge generating layer, and a charge transport layer. In some embodiments, they may also include an anti-curl back coating layer.

Typically, such flexible electrostatographic imaging member belts are prepared or fabricated from sheets cut from a continuous web of a flexible imaging member of the same composition. The sheets are generally rectangular or parallelogram in shape. All edges may be of the same length or one pair of parallel edges may be longer than the other pair of parallel edges. The sheets are formed into a belt by joining overlapping opposite marginal end regions of the sheet. A seam is typically produced in the overlapping marginal end regions at the point of joining. Joining may be effected by any suitable means. Typical joining techniques include welding (including ultrasonic), gluing, taping, heat fusing and the like.

For a seamed imaging belt to be acceptable, the seam must have acceptable mechanical strength, and the final image produced from across the seam must be comparable in quality to images formed across the remainder of the belt. This is a difficult task because the electrostatic properties across the seam depend on interrelated factors such as seam geometry, seam construction (such as adhesive beyond the seam), seam topology or morphology, seam thickness and thickness variations.

In addition to mechanical strength and electrical or electrostatic requirements, there are other problems when transferring toner images onto and off of a seam region of an imaging belt. For example, with most conventional seamed imaging belts, there is usually relatively poor cleaning around the seam region. To resolve this problem, the toner release and friction properties across the seam region have to be comparable to those of the rest of the belt. Furthermore, most prior art seamed imaging belts have a significant “step” where the belt overlaps to form the seam. That step can be as large as 75 microns. Such a step significantly interferes with transfer and cleaning. Thus if toner is transferred onto and off of the seam, the seam's friction, toner release, and topography are much more constrained than those of other seamed imaging belts.

From above it can be seen that a seam's topography is very important if one wants to form over its region or transfer therefrom, a toner image without significant degradation of the final toner image. Thickness variations and surface protrusions are detrimental characteristics of conventionally formed seams in such belts.

Conventional belts have the above problems because when a sheet of a an imaging belt material web is conventionally jointed, for example ultrasonically welded into a belt, the seam of the resulting multilayered electrostatographic imaging flexible member belt does create two splashings formed from the molten layers. One of the splashings is deposited at the top of the belt surface, and the other at the backside of the belt, adjacent to either side of the seam overlap. The conventionally jointed or welded seam of the belt may occasionally contain undesirable high protrusions such as peaks, ridges, spikes, and mounds.

For example, in U.S. Pat. No. 5,688,355 a method is disclosed for fabricating a flexible belt utilizing excimer laser ablation. In the method, a precision amount of material is removed from the bottom and the top of two opposite ends of a cut sheet of a web of a multi-layered imaging member prior to overlapping the two opposite ends and ultrasonically welding them into a seam. The resulting multi-layered imaging member belt has a welded seam and is claimed to have little added thickness and reduced amount of seam splashing formulation.

In addition, U.S. Pat. No. 6,453,783 discloses a method and apparatus for producing an endless flexible seamed belt using templates. A first form of the template is a mask template with a template aperture in the form of a puzzle cut pattern to be used in combination with an excimer laser. The template is placed between the excimer laser source and the belt material to be cut. As the excimer laser traverses the width of the belt, the laser forms a puzzle cut pattern on the belt. A second form of the template is a punch and die having patterned edges in the form of a puzzle cut pattern with extremely small nodes and kerfs. The cutting tolerances of the patterned edges make it necessary to fix the punch with respect to the die so that there is no misalignment of the punch and die between cutting operations. This is accomplished by resiliently fixing the punch to the die, rather than having the punch attached to the force generating assembly as in normal punch and die assemblies. Belt material is positioned between a stock gap between the punch and die and the force generating assembly is activated to provide the cutting force. Once the belt material is cut, the cutting force is removed and the force generating assembly returns to its retracted position. Both types of templates result in very clean cuts without deformation or distortion.

U.S. Pat. No. 6,368,440 discloses a flexible electrostatographic imaging member belt that comprises two ends with matching puzzle-cut patterns of fingers arranged to be joined. The belt is fabricated by a method comprising the steps of: first, joining the two belt ends to form a juncture; second, applying an adhesive strip to the juncture; third, applying a compressing force to the adhesive strip; fourth, heating the adhesive strip for a heating period; fifth, cooling the adhesive strip for a cooling period; thus forming a puzzle-cut seam; and, sixth, determining when the puzzle-cut seam is satisfactory. When it is determined the puzzle-cut seam is not satisfactory, the heating and cooling steps are repeated. When it is determined the puzzle-cut seam is satisfactory, the compressing force is removed. In one embodiment, the method determines when the puzzle-cut seam is satisfactory based on the total time heat is applied to the adhesive strip.

U.S. Pat. No. 6,318,223 discloses another method and apparatus for producing an endless flexible seamed belt using templates. A first form of the template is a mask template with a template aperture in the form of a puzzle cut pattern to be used in combination with an excimer laser. The template is placed between the excimer laser source and the belt material to be cut. As the excimer laser traverses the width of the belt, the laser forms a puzzle cut pattern on the belt. A second form of the template is a punch and die having patterned edges in the form of a puzzle cut pattern with extremely small nodes and kerfs. The cutting tolerances of the patterned edges make it necessary to fix the punch with respect to the die so that there is no misalignment of the punch and die between cutting operations. This is accomplished by resiliently fixing the punch to the die, rather than having the punch attached to the force generating assembly as in normal punch and die assemblies. Belt material is positioned between a stock gap between the punch and die and the force generating assembly is activated to provide the cutting force. Once the belt material is cut, the cutting force is removed and the force generating assembly returns to its retracted position. Both types of templates result in very clean cuts without deformation or distortion.

U.S. Pat. No. 6,652,691 discloses a process for providing an improved imaging member belt having a welded seam that exhibits greater resistance to dynamic fatigue induced seam cracking and delamination. An apparatus for achieving stress relaxation and eliminating protrusions in the seam region is also disclosed.

Thus, there is a continuing need for a method of fabricating flexible imaging belts each having an improved seam design that is thin in seam profile, without splashing formation and seam protrusion spots, and thus has a smooth surface topology, is resistant to seam cracking/delamination, and has a seam region physical continuity free of factors that damage imaging machine subsystems.

### SUMMARY

In accordance with the present disclosure, there has been provided a method of fabricating an endless flexible belt having a circumference L1 and a thin seam profile. The method includes (a) cutting a work sheet of flexible belt material from a web of such material so that the work sheet has a first end and a first end region, a second end and a second end region, and a length L2 that is D units greater than L1; (b) looping the work sheet and overlapping the first end region and the second end region thereof by D units to form an overlapping dual end region; (c) making a single slice through the overlapping dual end region to produce a first, male side and a second, female side of the slice, and to produce a belt-length sheet, the first, male side of the slice comprising a first, male end of the belt-length sheet, and the second, female side of the slice comprising a second, female end of the belt-length sheet; (d) looping the belt-length sheet, re-aligning and mating the first, male side and the second, female side of the single slice to form a no-discrepancy abutment; and (e) heating and fusing the no-discrepancy abutment to form an endless flexible belt having a thin profile seam including no undesirable thickness variations and no undesirable protrusions.

In accordance with another aspect of the present disclosure, there is provided apparatus for fabricating, from a web of flexible belt material having an inner surface and an outer surface, an endless flexible belt having a circumference L1 and a thin profile seam. The apparatus includes (a) a slicing tool having (i) a razor-thin slicing edge for making a single slice through an overlapped dual end region of a worksheet length of the flexible belt material to create a belt-length sheet, (ii) a first side of the razor-thin edge that forms a first, male side of the single slice at a first end of the belt-length sheet, and (iii) a second side of the razor-thin edge that forms a second, female side of the single slice at a second end of the belt-length sheet; (b) supporting members for supporting the first, male side and the second, female side of the single slice at the first end and the second end of the belt-length sheet into a loop-forming, mating and no-discrepancy abutment; and (c) heaters for heating and fusing the no-discrepancy abutment to form an endless flexible belt having a thin profile seam including no undesirable thickness variations and no undesirable protrusions.

### BRIEF DESCRIPTION OF THE DRAWINGS

In the detailed description presented below, reference is made to the drawings, in which:

FIG. 1 is schematic illustration of an electrostatographic imaging machine including an endless flexible belt made in accordance with the present disclosure;

FIG. 2 is an illustration of an endless flexible belt including a thin profile seam made in accordance with the present disclosure;

FIG. 3 illustrates a portion of a web of flexible belt material and a worksheet thereof for fabricating an endless flexible belt in accordance with the present disclosure;

FIG. 4 is an illustration of the next looping and slicing steps, and the apparatus therefor in accordance with the present disclosure;

FIG. 5 is a top view illustration of the heating and fusing steps, and the apparatus therefor in accordance with the present disclosure;

FIG. 6 is a vertical side view illustration of the heating and fusing steps, and the apparatus therefor in accordance with the present disclosure;

FIG. 7 illustrates a typical surface morphological profile of a conventional seam of a flexible electrostatographic belt having a 120 micron high seam protrusion spike; and

FIG. 8 shows the corresponding surface morphological profile of a thin profile seam of a flexible electrostatographic belt made in accordance the method and apparatus of the present disclosure.

### DETAILED DESCRIPTION

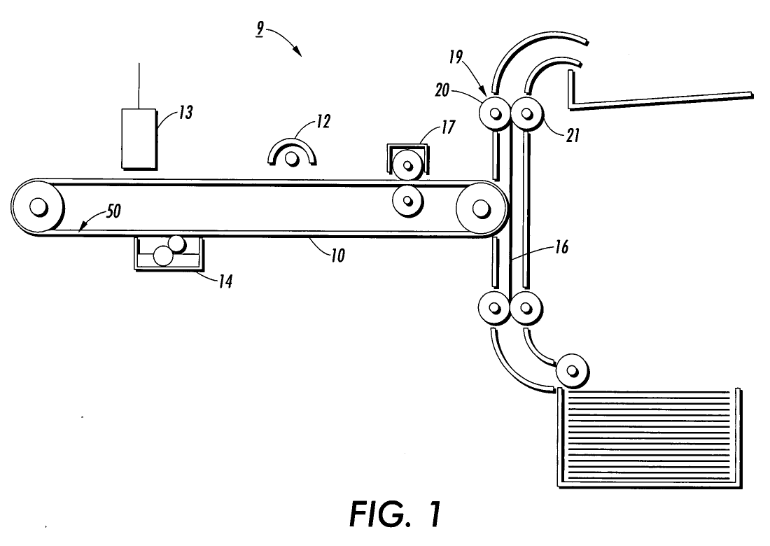

Referring first to FIG. 1, there is illustrated an electrostatographic imaging machine 9 including an endless flexible belt made in accordance with the present disclosure. As illustrated, in a typical electrostatographic imaging machine, a light image of an original to be copied is recorded in the form of an electrostatic latent image on an imaging side of a moving photosensitive member or photoreceptor 10, such as an endless flexible belt 10 made in accordance with method and apparatus of the present disclosure. The electrostatic latent image is subsequently rendered visible at a development station 14 by the application of electroscopic thermoplastic resin particles, which are commonly referred to as toner. Specifically, the photoreceptor 10 is charged on its imaging surface by means of an electrical charger 12. The photoreceptor 10 is then image-wise exposed to light from an optical system or an image input device 13, such as a laser and light emitting diode, to form the electrostatic latent image thereon. Generally, the electrostatic latent image is developed by bringing a developer mixture from developer station 14 into contact therewith.

After the electrostatic latent image has been so developed, it is subsequently transferred to a copy sheet 16 by transfer means 15. After such transfer, the copy sheet 16 is advanced to fusing station 19, depicted in FIG. 1 as fusing and pressure rolls 20, 21, wherein the developed image is heated and fused to copy sheet 16. This is accomplished by passing the copy sheet 16 between the fusing roll 20 and pressure roll 21, thereby forming a permanent copy. Fusing may also be accomplished by other fusing members such as a fusing belt in pressure contact with a pressure roller, fusing roller in contact with a pressure belt, or other like systems. Photoreceptor 10, subsequent to transfer, advances to a cleaning station 17, wherein any residual toner left on photoreceptor 10 is cleaned therefrom by use for example of a blade 22 (as shown in FIG. 1), a brush, or other cleaning apparatus.

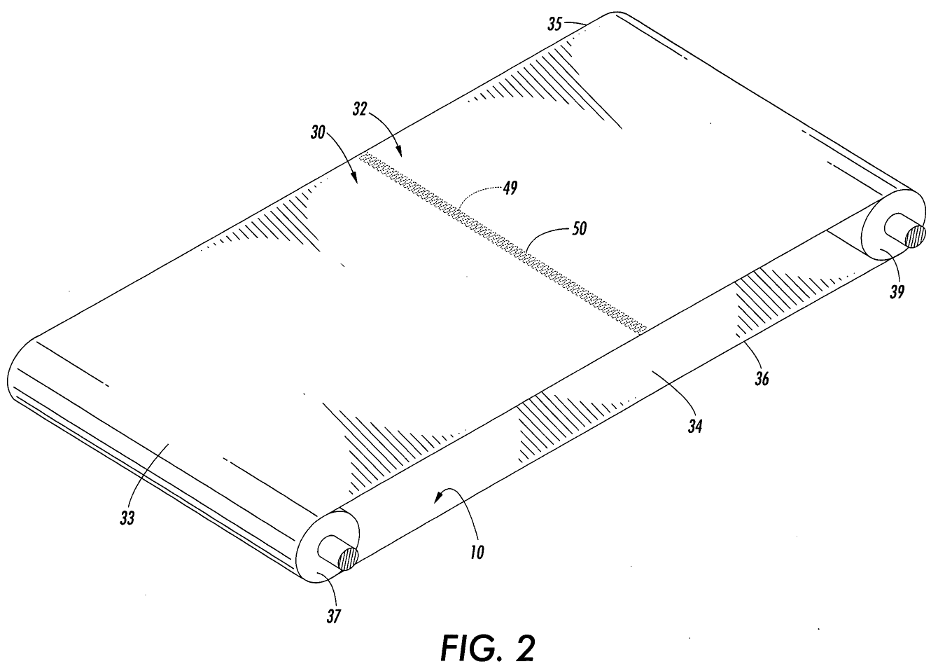

A pointed out above, the quality of the image so formed, developed and transferred as described above depends in part on the morphological characteristics of the seam 50 (FIG. 2) that completes the fabrication of the endless flexible belt or photoreceptor 10.

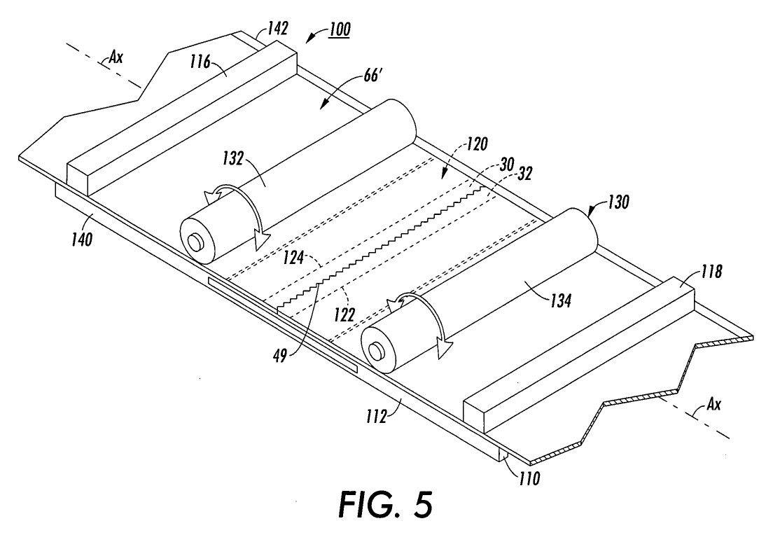

Referring now to FIG. 2, there is shown the flexible imaging belt 10 with a first, male end 30 and a second, female end 32 that initially were aligned and mated to form a no-discrepancy abutment 49 (FIG. 5), and were then heated and compression fused without the use of any adhesives in accordance with the present disclosure to form a low profile seam 50. The flexible imaging belt 10 in addition to the two ends 30, 32, has a circumference L1, an outer surface 33, an inner surface 34, as well as a first edge 35 and a second edge 36. The ends 30, 32 as cut or sliced in accordance with the method (to be described in detail below) of the present disclosure, may have anyone of a number patterns, including puzzle-cut patterns, as described in the prior art. As shown, the length or circumference L1 of flexible belt 10 extending between the two ends 30 and 32 is loop-mounted on rollers 37 and 39. As illustrated in FIG. 1, the flexible imaging belt 10 can be utilized within an electrostatographic imaging device or machine and may be a single film substrate member or a member having a film substrate layer combined with one or more additional coating layers.

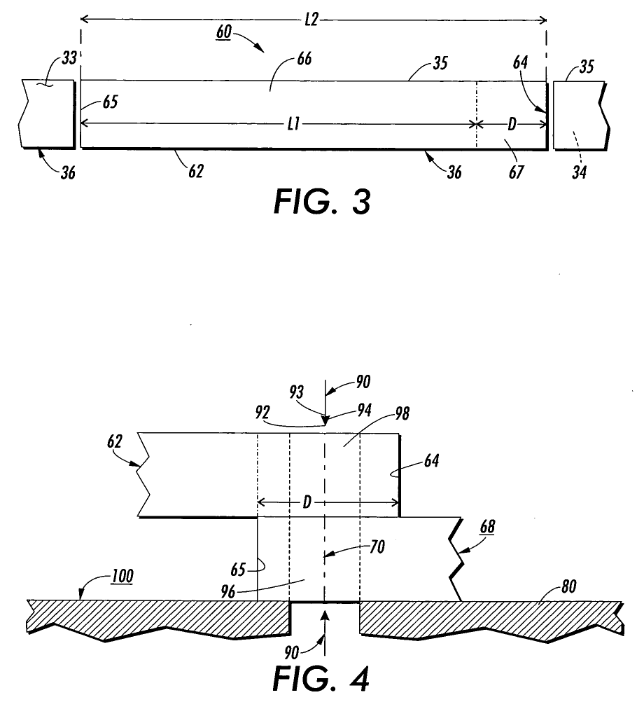

Referring now to FIG. 3, a long web of flexible imaging belt material 60 is illustrated. As shown, the web 60 can be cut in any suitable manner into worksheet portions 62, each of which has the first edge 35, the second edge 36, a first-cut end 64, a second-cut end 65, an overall length L2 (66 plus 67) that is greater than L1 (circumference of the flexible imaging belt 10) by a portion 67 that has a length differential D units. The method of the present disclosure thus includes (a) cutting the worksheet 62 of the flexible belt material from the web 60 of flexible belt material as shown in FIG. 3, and then (b) first looping the work sheet 62, outer surface 33 (FIG. 2) out or outwardly, and overlapping the first-cut end 64 and the second-cut end 65 thereof by D units (FIG. 4) to form the overlapping dual end region 68.

Referring now to FIG. 4, there are illustrated parts of the apparatus 100 and method for creating a belt-length sheet 66 from the worksheet 62 using a single slice 70 through a dual-end overlapping portion 68 of the worksheet 62. The apparatus 100 may include a first support member 80 for supporting the dual-end overlapping portion 68, and a slicing tool 90. The slicing tool 90 represented in FIG. 4 by an arrow symbol should have (i) a razor-thin slicing edge 92 (tip of the arrow) for making the single slice 70 through the overlapped dual-end region 68 of the worksheet 62 of the flexible belt material so as to create the belt-length sheet 66. The slicing tool 90 further has (ii) a first side 93 of the razor-thin edge that forms a first, male side 96 of the single slice 70 at a first end 30 (FIG. 2) of the belt-length sheet 66, and (iii) a second side 94 of the razor-thin edge that forms a second, female side 98 of the single slice 70 at a second end 32 of the belt-length sheet 66.

The method of the present disclosure thus next includes making the single slice 70 from the first edge 35 to the second edge 36, with the single slice 70 having the first, male side 96 that may include puzzle-cut tabs, and the second, female side 98 that may include puzzle-cut mating edges as are well known in the prior art. The single slice 70 as such is made through the overlapping dual-end region 68 in order to produce the belt-length sheet 66 having the length L1. As made, the first, male side 96 comprises the first, male end 30 of the belt-length sheet 66, and eventually of the belt 10, and the second, female side 98 comprises second, female end 32 of the belt-length sheet 66 and hence of the belt 10. As further illustrated in FIG. 4, the single slice 70 is made at a slice point that is located one-half D units from the first-cut end 64 and the same distance from the second-cut end 65, thus discarding one-half D units at each such end for a total (one-half D units plus one-half d units) of D units, thereby resulting in the remaining belt-length sheet 66 of length L1. Given the sharpness (razor-thin edge) of the tool 90, the single slice 70 is a clean slice with no crevice and no loss of material from the cut.

The single slice 70 is thus made simultaneously through the first-cut end 64 and the second-cut end 65 of the worksheet 62, thereby assuring perfectly re-mateable male and female sides 96, 98 in the discarded portions of the ends 64, 65, as well as in the resulting first, male end 30 and second, female end 32 of the belt-length sheet 66. The single slice or cut 70 can of course be of any suitable pattern producing male and female sides depending on the pattern shape of the tool 90, and as such includes non-puzzle cuts, as well as all types of puzzle-cuts as disclosed for example in U.S. Pat. No. 6,751,435, relevant portions of which are incorporated herein by reference.

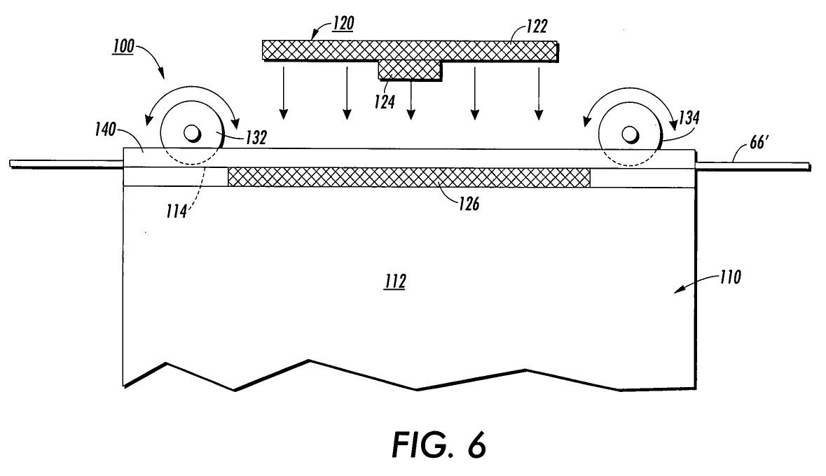

Referring now to FIGS. 5 and 6, other parts of the apparatus 100 and method of the present disclosure for re-mating, re-aligning the first, male end 30 and second, female end 32 of the belt-length sheet 66 into a no-discrepancy abutment 49, and then heating and compression fusing the no-discrepancy abutment 49 into the low profile seam 50, are illustrated. As shown, the other parts of the apparatus 100 include supporting means 110 for supporting the first, male end 30 (which was the same as the first, male side 96 of the single slice 70) and the second, female end 32 (which was the same as the second, female side 98 of the single slice 70) of a belt-length loop of the sheet 66 so that such ends 30, 32 mate and no-discrepancy abutment 49. The supporting means 110 for example include a second supporting member 112 having a flat smooth surface 114, and at least one clamping device 116, 118 for clamping regions of the belt-length loop 66′ around the no-discrepancy abutment 49 to a portion of supporting member 112.

Thus the method of the present disclosure further includes next looping the belt-length sheet 66 into a belt-length loop 66′ having the outer surface 33 out, re-aligning and mating end-to-end the first, male end 30, and the second, female end 32 of the belt-length sheet 66 to form the no-discrepancy abutment 49 as shown, and then heating and fusing the no-discrepancy abutment 49 to form the thin profile seam 50 and the endless flexible belt 10.

As shown in FIGS. 5 an 6, the apparatus 100 includes heating means 120 for heating and fusing the no-discrepancy abutment 49 in order to form the thin profile seam 50 and the endless flexible belt 10. The heating means 120 may include a first heating device 122 for heating the outer surface 33 of the belt-length loop 66′ around the no-discrepancy abutment 49. The first heating device 122 may also include a relatively greater intensity heating portion 124 located directly over the no-discrepancy abutment 49 for heating the no-discrepancy abutment more intensely than other areas surrounding such abutment 49. The heating means 120 also include a second heating device 126 for heating the inner surface 34 of the belt-length loop 66′ around the no-discrepancy abutment 49.

The apparatus 100 also includes compressing means 130 for compressing and flowing belt-length loop material around the no-discrepancy abutment 49 into the no-discrepancy abutment 49. The compressing means 130 for example comprise at least one rotatable roller 132, 134 that is rotatable reversibly along a longitudinal axis Ax of the belt-length loop 66′. In one embodiment, the compressing means comprise a pair of rotatable rollers 132, 134 that are each rotatable reversibly as shown along the longitudinal axis Ax of the belt-length loop 66′. The purpose of the roller or rollers 132, 134, is for compressing and flowing belt-length lop material around the no-discrepancy abutment 49 only in a first direction along the longitudinal axis Ax of the belt-length loop 66′, and into the no-discrepancy abutment 49.

According to one aspect of the method of the present disclosure, with the clamps 116, 118 in operation, and with the heating means 120 fully operational, first one compression roller, for example roller 132, is first rotated clockwise from a first position away from the abutment 49 towards and past the abutment 49 into a second position therefor. That same compression roller 132 is then reversibly rotated counter-clockwise from such second position beyond the abutment 49 back across the abutment 49 to the initial position to the left of the abutment 49 as shown. This has the desired effect of causing heated belt-length loop material in the heated region around the abutment 49 to flow in the direction of movement of such compression roller. In the embodiment having a pair of such compression rollers 132, 134, the movement of the first roller 132 is replicated appositely with the appositely located compression roller 134.

According to one more aspect of the present disclosure, the apparatus 100 includes edge guides 140, 142 for preventing compressed belt-length loop material from flowing in a second, cross-axial direction beyond the normal position of the first edge 35 and the second edge 36 of the belt-length loop 66′. As illustrated, the region of the loop 66′ around the abutment 49 is recessed within the guides 140, 142 so that the width and thickness of the belt 10 around the finished seam 50 are not adversely affected by cross-axial flow of material beyond either of a first edge and a second edge of the belt-length loop. The resulting thin profile seam 50 as formed includes no undesirable thickness variations and no undesirable protrusions. As a consequence, the resulting seamed flexible belt 10 functions essentially like a seamless belt and meets stringent imaging requirements.

A number of examples are set forth hereinbelow and are illustrative of different compositions and conditions that can be utilized in practicing the seam designs disclosed herein. All proportions are by weight unless otherwise indicated. It will be apparent, however, that the development can be practiced with many types of compositions and can have many different uses in accordance with the disclosure above and as pointed out hereinafter.

Imaging Member Preparation Example

A flexible electrophotographic imaging member web stock was prepared by providing a roll of titanium coated biaxially oriented thermoplastic polyester (PET, Melinex, available from ICI Americas Inc.) substrate having a thickness of 3 mils (76.2 micrometers). Applied thereto, using a gravure applicator, was a solution containing 50 parts by weight of 3-aminopropyltriethoxysilane, 50.2 parts by weight of distilled water, 15 parts by weight of acetic acid, 684.8 parts by weight of 200 proof denatured alcohol, and 200 parts by weight of heptane. This layer was then dried to a maximum temperature of 290° F. (143.3° C.) in a forced air oven. The resulting blocking layer had a dry thickness of 0.05 micrometer.

An adhesive interface layer was then prepared by applying to the blocking layer a wet coating containing 5 percent by weight, based on the total weight of the solution, of polyester adhesive (Mor-Ester 49,000, available from Morton International, Inc.) in a 70:30 volume ratio mixture of tetrahydrofuran/cyclohexanone. The adhesive interface layer was dried to a maximum temperature of 275° F. (135° C.) in a forced air oven. The resulting adhesive interface layer had a dry thickness of 0.07 micrometers.

The adhesive interface layer was thereafter coated with a photogenerating layer containing 7.5 percent by volume of trigonal selenium, 25 percent by volume of N,N′-dipheny-N,N′-bis(3-methylphenyl)-1,1′-biphenyl-4,4′-diamine, and 67.5 percent by volume of polyvinylcarbazole. This photogenerating layer was prepared by introducing 160 gms of polyvinylcarbazole and 2,800 mis of a 1:1 volume ratio of a mixture of tetrahydrofuran and toluene into a 400 oz. amber bottle. To this solution was added 160 gms of trigonal selenium and 20,000 gms of ⅛ inch (3.2 millimeters) diameter stainless steel shot. This mixture was then placed on a ball mill for 72 to 96 hours. Subsequently, 500 gms of the resulting slurry were added to a solution of 36 gms of polyvinylcarbazole and 20 gms of N,N′-diphenyl-N,N′-bis(3-methylphenyl)-1,1′-biphenyl-4,4′-diamine dissolved in 750 mis of 1:1 volume ratio of tetrahydrofuran/toluene. This slurry was then placed on a shaker for 10 minutes. The resulting slurry was thereafter applied to the adhesive interface by extrusion coating to form a layer having a wet thickness of 0.5 mil (12.7 micrometers). However, a strip about 3 mm wide along one edge of the coating web, having the blocking layer and adhesive layer, was deliberately left uncoated by any of the photogenerating layer material to facilitate adequate electrical contact with the ground strip layer that is applied later. This photogenerating layer was dried to a maximum temperature of 280° F. (138° C.) in a forced air oven to form a dry thickness photogenerating layer having a thickness of 2.0 micrometers.

This coated imaging member web was simultaneously coated over with a charge transport layer and a ground strip layer by co-extrusion of the coating materials. The charge transport layer was prepared by introducing into an amber glass bottle in a weight ratio of 1:1 (or 50% wt of each) of N,N′-diphenyl-N,N′-bis(3-methylphenyl)-1,1′-biphenyl-4,4′-diamine and Makrolon 5705, a Bisphenol A polycarbonate thermoplastic having a molecular weight of about 120,000 commercially available from Farbensabricken Bayer A.G. The resulting mixture was dissolved to give 15 percent by weight solid in methylene chloride. This solution was applied on the photogenerator layer by extrusion to form a coating, which upon drying gave a thickness of 24 micrometers.

The strip, about 3 mm wide, of the adhesive layer left uncoated by the photogenerator layer, was coated with a ground strip layer during the co-extrusion process. The ground strip layer coating mixture was prepared by combining 23.81 gms. of polycarbonate resin (Makrolon 5705, 7.87 percent by total weight solids, available from Bayer A.G.), and 332 gms of methylene chloride in a carboy container. The container was covered tightly and placed on a roll mill for about 24 hours until the polycarbonate was dissolved in the methylene chloride. The resulting solution was mixed for 15-30 minutes with about 93.89 gms of graphite dispersion (12.3 percent by weight solids) of 9.41 parts by weight of graphite, 2.87 parts by weight of ethyl cellulose and 87.7 parts by weight of solvent (Acheson Graphite dispersion RW22790, available from Acheson Colloids Company) with the aid of a high shear blade dispersed in a water cooled, jacketed container to prevent the dispersion from overheating and losing solvent. The resulting dispersion was then filtered and the viscosity was adjusted with the aid of methylene chloride. This ground strip layer coating mixture was then applied, by co-extrusion with the charge transport layer, to the electrophotographic imaging member web to form an electrically conductive ground strip layer having a dried thickness of about 14 micrometers.

The resulting imaging member web containing all of the above layers was then passed through a maximum temperature zone of 257° F. (125° C.) in a forced air oven to simultaneously dry both the charge transport layer and the ground strip. The imaging member at this point, if unrestrained, will spontaneously curl upward, an anti-curl back coating is needed to render its desired flatness. An anti-curl coating was prepared by combining 88.2 gms of polycarbonate resin (Makrolon 5705, available from Goodyear Tire and Rubber Company) and 900.7 gms of methylene chloride in a carboy container to form a coating solution containing 8.9 percent solids. The container was covered tightly and placed on a roll mill for about 24 hours until the polycarbonate and polyester were dissolved in the methylene chloride. 4.5 gms of silane treated microcrystalline silica was dispersed in the resulting solution with a high shear dispersion to form the anti-curl coating solution. The anti-curl coating solution was then applied to the rear surface (side opposite the photogenerator layer and charge transport layer) of the electrophotographic imaging member web by extrusion coating and dried to a maximum temperature of 220° F. (104° C.) in a forced air oven to produce a dried coating layer having a thickness of 13.5 micrometers.

Prior Art Overlap Seam Preparation

The prepared flexible electrophotographic imaging member web stock of the Imaging Member Preparation Example above, having a width of 353 mm, was cut transversely to provide one rectangular sheet of precise 508 mm in length and having four vertically sides for flexible imaging member belt seaming preparation. The opposite ends of the first one of these imaging member cut sheets were brought together to give 1 mm overlap and then joined by ultrasonic energy seam welding process using a 40 Khz horn frequency to produce an electrophotographic imaging member belt having an ultrasonically welded prior art overlap seam control, which, according to that illustrated in FIG. 2, had a top seam splashing surface morphology 74, a displaying of physical discontinuity step 72 with a junction point 76, and a 1.7 times differential seam area thickness than that of the bulk of the belt.

Thin Profile Prior Art Seam Preparation

The prepared electrophotographic imaging member web stock of the Imaging Member Preparation Example above, having a width of 353 mm, was cut through the cross web direction, with a puzzle cut die to give a rectangular sheet having a pair of opposite ends consisting of correspondingly complementing puzzle cut patterns. For imaging member belt preparation, the rectangular imaging member cut sheet was looped in order to bring the pair of opposite puzzle cut pattern ends together for mating and mechanical interlocking of the puzzle cut elements into a butt joint alignment having a 35 micrometers kerf or crevice and a 508 mm belt circumference.

The mated puzzle cut end pair of the looped imaging member sheet was then subjected to compression/heat processing step, held at 80 lbs/in²/200° C. for 6 seconds and then cooling for 15 seconds, to allow materials flow and fill the crevice for fusion bonding; therefore the compression/heat processing did effect direct imaging layers heat fusion of the puzzle cut mated elements into an imaging member belt having An abutted fusion bonded prior art seam.

Seam Preparation According to this Diclosure

The prepared flexible electrophotographic imaging member web stock of the Imaging Member Preparation Example above, having a width of 353 mm, was cut in any suitable manner through the cross web direction to give a rectangular sheet of 520 mm in length. The two opposite ends of the rectangular imaging member cut sheet were then brought together and overlapped forming a dual-end overlapping portion in accordance with the present disclosure, such as to give a circumferential belt dimension of 508 mm. With a shear puzzle cut die (cutting or slicing tool), a perfect male-female matching ends pair is created. The mal, female matching ends pair, having a perfectly fitted butt joint alignment without a crevice, was then subjected to compression/heat processing step, again held at 80 lbs/in²/200° C. for 6 seconds and then cooling for 15 seconds to effect fusion bonding result, by following the detailed descriptions presented in FIGS. 5 and 6. The prepared flexible imaging member belt 10 had a thin profile bonded seam 50 of present disclosure with virtually no differential seam area thickness or protrusions.

Physical and Mechanical Evaluation

The three flexible imaging member belts comprising the Prior Art Overlap seam, the Thin profile Prior Art Seam, and the thin profile disclosure seam 50 described above were analyzed for respective seam surface topology using a surface analyzer, Surftest 402, available from Mitutoyo Company. The surface profile obtained for the ultrasonically welded control prior art seam, as that shown in FIG. 2, had a 1.0 micrometer seam splash, a splash height of 68 micrometer, a rough surface roughness Ra value of 7.1, and a differential seam area thickness increase of about 80 micrometers. Although both the prior art fusion bonded seam and the disclosure fusion bonded seam had virtually nil added seam area differential thickness, nevertheless the prior art seam was found to have a slight thickness depression of approximately 6.5 micrometers in depth around the bonding line due to material flowing into and fill the 35 micrometers crevice to effect bonding; in other words, this localized surface depression was the outcome of localized reduction in imaging layers thickness due to materials flowing from the tip of mated elements to fill the crevice gap for achieving effectual heat fusion seam bonding. By comparison, the disclosure seam was prepared by fusion mating of a perfectly fitted male-female patterns pair, created to give no seam crevice through the use of the present disclosure cutting technique; as a matter of fact, the disclosure compression/heat fusion bonded seam gave a physical continuity seam area of the belt.

When evaluated for tensile seam rupture strength using an Instron Mechanical Tester, the ultrasonic welded overlap seam had a seam rupture strength about 54.2 lbs/in., slightly higher than the 52.3 lbs/in obtained disclosure fusion bonded seam counterpart; however, this small differences in strength is of practical in significant because it is still much greater than the rupture strength of 35 lbs/in. seam SPEC for flexible belt.

By sharp contrast, the thin profile fusion bonded prior art seam (formed from a 30 micrometers crevice joint) had given a seam rupture strength of only 15.6 lbs/in. This is too low a seam strength value to warrant mechanical seam integrity of belt life during dynamic imaging member belt machine function in the field.

Dynamic Imaging Belt Cycling

Two of the prepared flexible electrophotographic imaging member belts described above (one having the ultrasonically welded prior art overlap seam control and the other a fusion bonded seam of this disclosure) were each dynamically cycled tested, to the point of onset of seam failure, in a xerographic machine utilizing a belt support module comprising a 25.24 mm diameter drive roller, a 25.24 mm diameter stripper roller, and a 29.48 mm diameter tension roller to exert to each belt a tension of 1.1 pounds per inch. The belt cycling speed was set at 65 prints per minute.

The control imaging member belt, was cyclic tested to produce an equivalent of only about 56,000 print copies and terminated for the reason of onset of seam cracking/delamination. During dynamic belt cycling process, a slight belt motion speed disturbance was registered each time the seam of the belt was transported passing over a belt support module roller, because the seam splashing coupled with the added differential seam region thickness did essentially behave as a speed bump to impact the belt motion quality.

With the very same machine, belt cycling procedures were repeated for the disclosure seamed belt. Neither seam failure nor cleaning blade wear problem were observed after completion of approximately 750,000 equivalent print copies of belt cyclic testing. It is important to further point out that, unlike the ultrasonically welded prior art seamed belt control counterpart, no undesirable dynamic belt motion quality impact was not notable, since the imaging member belt, prepared to have a butt-joint invention fusion bonded seam, having smooth top and bottom topology, excellent physical continuity, and no thickness variance, did function virtually like a seamless belt.

Consequently, the thin profile, fusion bonded seam design disclosed herein reduces seam cracking/delamination problems, having no seam splash junction physical discontinuity, provides smoother surface topology of no added seam region thickness, excellent physical continuity, improved belt motion quality, cleaning blade wear suppression, good seam rupture strength, and very importantly, a prepared seamed belt is substantially free of high protrusion spots in the seam to thereby reduce imaging member belt rejection rates to increase imaging member belt production yield as well. Furthermore, the seam quality is improved utilizing the seam design of this disclosure such that the manual seam inspection steps may, in some instances, be eliminated.

Although it can be rationalized that the fusion bonding of the puzzle cut pattern should give stronger seam rupture strength than that if the bonded fusion seam was formed from a pair of straight cut ends, because the puzzle cut ends had a much longer bonding line than that of the straight cut ends, however, the present disclosure concept does extend to include fusion bonded seamed belts having a seam formed from mating/fusing straight cut ends.

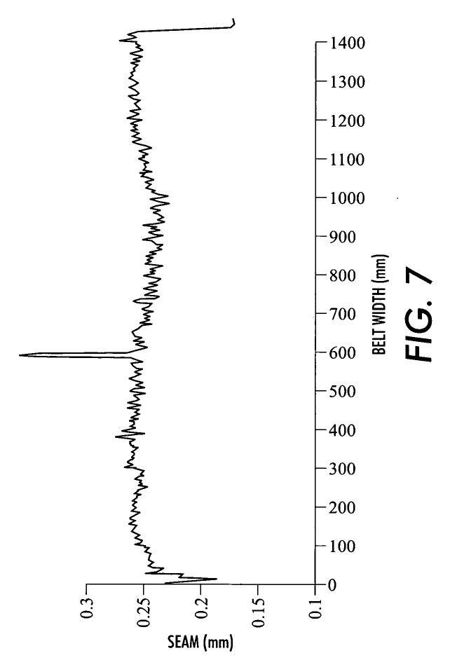

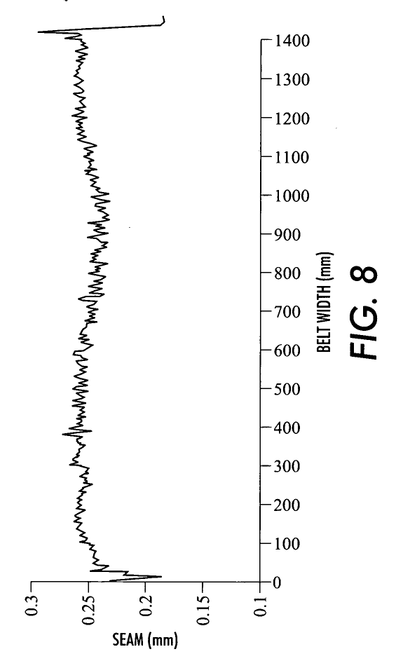

The above comparative results are illustrated in FIGS. 7 and 8. For example, FIG. 7 shows a morphological surface profile measured for a seam of a typical ultrasonically welded seam of an electrophotographic imaging member belt having an anomaly high seam protrusion, a 120 micrometer spike, that is capable of cutting an elastomeric cleaning blade. This undesirable protrusion also interferes with the operational functions of electrostatographic imaging machine subsystems. Illustrated in FIG. 8 is a morphological surface profile measured for the thin profile seam 50 of the present disclosure. As can be seen, it is free of the protrusion spike as formed without undergoing any further process or treatment for protrusion elimination.

As can be seen, there has been provided a method of fabricating, from a web of flexible belt material having an inner surface and an outer surface, an endless flexible belt having a circumference L1 and a thin profile seam. The method includes (a) cutting a work sheet of the flexible belt material from the web of flexible belt material, the work sheet having a first edge and a second edge, a first end, a first end region, a second end, a second end region, and a length L2 being D units greater than L1; (b) first looping the work sheet, outer surface out, and overlapping the first end region and the second end region thereof by D units to form an overlapping dual end region; (c) making a single slice from the first edge to the second edge, the single slice having a first, male side and a second, female side through the overlapping dual end region to produce a belt-length sheet having a length L1, the first male side comprising a first, male end of the belt-length sheet, and the second, female side comprising a second, female end of the belt-length sheet; (d) next looping the belt-length sheet into a belt-length loop having outer surface out, re-aligning and mating end-to-end the first, male end and the second, female end of the belt-length sheet to form a no-discrepancy abutment of the first, male end and the second, female end; and (e) heating and fusing the no-discrepancy abutment to form an endless flexible belt having the first edge, the second edge, and a thin profile seam including no undesirable thickness variations and no undesirable protrusions.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of fabricating, from a web of flexible belt material having an inner surface and an outer surface, an endless flexible belt having a circumference L1 and a thin profile seam, the method comprising:
(a) cutting a work sheet of said flexible belt material from said web of flexible belt material, said work sheet having a first edge and a second edge, a first end, a first end region, a second end, a second end region, and a length L2 being D units greater than L1;
(b) first looping said work sheet, outer surface out, and overlapping said first end region and said second end region thereof by D units to form an overlapping dual end region;
(c) making a single slice from said first edge to said second edge, said single slice having a first, male side and a second, female side through said overlapping dual end region to produce a belt-length sheet having a length L1, said first male side comprising a first, male end of said belt-length sheet, and said second, female side comprising a second, female end of said belt-length sheet;
(d) next looping said belt-length sheet into a belt-length loop having outer surface out, re-aligning and mating end-to-end said first, male end and said second, female end of said belt-length sheet to form a no-discrepancy abutment of said first, male end and said second, female end; and
(e) heating and fusing said no-discrepancy abutment to form an endless flexible belt having said first edge, said second edge, and a thin profile seam including no undesirable thickness variations and no undesirable protrusions.

2. The method of claim 1, wherein said single slice is made at a slice point located one-half D units from said first end and from said second end producing a belt-length sheet of length L1.

3. The method of claim 1, wherein said step of making a single slice comprises making a clean slice with no loss of material.

4. The method of claim 1, wherein said step of heating and fusing includes a step of compressing and flowing material around said no-discrepancy abutment in a first direction.

5. The method of claim 1, wherein said step of heating and fusing comprises heating outer and inner surfaces of said belt-length loop along said no-discrepancy abutment.

6. The method of claim 4, wherein said step of compressing and flowing material includes preventing compressed material from flowing beyond certain points in a second direction.

7. The method of claim 4, wherein said first direction is along a longitudinal axis of said belt-length loop into said no-discrepancy abutment.

8. The method of claim 4, wherein said step of compressing and flowing material around said no-discrepancy abutment includes flowing material around said first, male end and around said second, female end into said no-discrepancy abutment.

9. The method of claim 5, wherein said step of heating and fusing comprises heating said no-discrepancy abutment more intensely than areas surrounding it.

10. The method of claim 6, wherein said second direction is an edge-to-edge direction across a width of said belt-length loop, and said certain points comprise said first edge and said second edge.

11. Apparatus for fabricating, from a web of flexible belt material having an inner surface and an outer surface, an endless flexible belt having a circumference L1 and a thin profile seam, the apparatus comprising:
(a) a slicing tool having (i) a razor-thin slicing edge for making a single slice through an overlapped dual end region of a worksheet length of said flexible belt material to create a belt-length sheet, (ii) a first side of said razor-thin edge that forms a first, male side of said single slice at a first end of said belt-length sheet, and
(iii) a second side of said razor-thin edge that forms a second, female side of said single slice at a second end of said belt-length sheet;
(b) supporting means for supporting said first, male side and said second, female side of said single slice at said first end and said second end of said belt-length sheet into a loop-forming, mating and no-discrepancy abutment; and
(c) means for heating and fusing said no-discrepancy abutment to form an endless flexible belt having a thin profile seam including no undesirable thickness variations and no undesirable protrusions.

12. The apparatus of claim 11, wherein said supporting means include a flat smooth surface.

13. The apparatus of claim 11, wherein said means for heating and fusing include a relatively higher intensity heating means directly over said no-discrepancy abutment.

14. The apparatus of claim 11, including compressing means for compressing and flowing material around said no-discrepancy abutment into said no-discrepancy abutment.

15. The apparatus of claim 11, including means for preventing compressed material from flowing in an edge-to-edge direction across a width of said belt-length loop beyond either of a first edge and a second edge of the belt-length loop.

16. The apparatus of claim 11, wherein said supporting means include at least one clamping device for clamping regions around said no-discrepancy abutment of a belt-length loop of said belt-length sheet to a portion of said supporting means.

17. The apparatus of claim 13, including a first heating device for heating an outer surface of said belt-length loop around said no-discrepancy abutment.

18. The apparatus of claim 13, including second heating means for heating an inner surface of said belt-length loop around said no-discrepancy abutment.

19. The apparatus of claim 14, wherein said compressing means comprise at last one rotatable roller.

20. The apparatus of claim 14, wherein said compressing means comprise a pair of oppositely arranged rotatable rollers.
